(19) United States
(12) Patent Application Publication
(10) Pub. No.: US 2006/0056327 A1
(43) Pub. Date: Mar. 16, 2006

(54) Adaptive pre-equalization method and apparatus

(76) Inventor: Edmund Coersmeier, Bochum (DE)

Correspondence Address: ROBERT M BAUER, ESQ.;LACKENBACH SIEGEL, LLP, 1 CHASE ROAD, SCARSDALE, NY, 10583, US

(21) Appl. No.: 10/520,383

(22) PCT Filed: Jul. 15, 2002
(86) PCT No.: PCT/IB02/02775

§ 371 Date: Jan. 4, 2005

(51) Int. Cl. H04J 3/08; H04B 7/14

(52) U.S. Cl. 370/315

(57) ABSTRACT

An adaptive pre-equalizer is disclosed to compensate amplitude ripples in a low cost transmitter pass-band filter. A filtered-x LMS algorithm is proposed to calculate the equalizer coefficients. To this purpose, the modulated RF signal is demodulated at the transmitter and subtracted from a filtered version of the original base band signal. The impulse response of the low-cost transmit filter is approximated by a delay. The disclosure may be applied to direct conversion or heterodyne transmitters using OFDM.

### FIELD OF THE INVENTION

The present invention relates to a method and apparatus for equalizing a transmission characteristic of a signal processing circuitry, such as a direct conversion or heterodyne transmitter using e.g. an Orthogonal Frequency Division Multiplexing (OFDM) scheme.

### BACKGROUND OF THE INVENTION

The Institute of Electrical and Electronics Engineers (IEEE) has developed a new specification 802.11a which represents the next generation of enterprise-class wireless local area networks (LANs). Among the advantages it has over current technologies are greater scalability, better interference immunity, and significantly higher speed, which simultaneously allows for higher bandwidth applications.

OFDM is used as a new encoding scheme which offers benefits over spread spectrum in channel availability and data rate. Channel availability is significant because the more independent channels that are available, the more scalable the wireless network becomes. The high data rate is accomplished by combining many lower-speed subcarriers to create one high-speed channel. A large (wide) channel can transport more information per transmission than a small (narrow) one. The subcarriers are transmitted in parallel, meaning that they are sent and received simultaneously. The receiving device processes these individual signals, each one representing a fraction of the total data that, together, make up the actual signal. With this many subcarriers comprising each channel, a tremendous amount of information can be sent at once.

The IEEE 802.11a wireless LAN standard defines a high system performance and therefore requires a certain signal accuracy for the OFDM transmitter output. Taking the analog base-band and radio frequency (RF) filter imperfections into account it is necessary to equalize the signal stream before transmission. The performance of a transmitter output signal is strongly dependent on the analog filter accuracy. To reach high signal accuracy, expensive and precise filters have to be used. However, in high volume products it is recommended to have those filters as cheap as possible. It may be possible to insert low-cost and non-precise analog CONFIRMATION COPY transmitter filters if an improved equalizer is installed to compensate large amplitude ripple and group delay in the transmitter pass-band.

### SUMMARY OF THE INVENTION

It is therefore an object of the present invention to provide an improved equalization method and apparatus, by means of which the signal accuracy at the transmitter output can be improved to thereby reduce filter requirements.

This object is achieved by a method of equalizing a transmission characteristic of a signal processing circuitry, said method comprising the steps of:
obtaining a difference between an output signal of said signal processing circuitry and an input signal of an equalizing function;
approximating a gradient of said difference based on said obtained difference and an approximation of said transmission characteristic; and
updating control values of said equalizing function based on said approximated gradient.

Additionally, the above object is achieved by an apparatus for equalizing a transmission characteristic of a signal processing circuitry, said apparatus comprising:
comparing means for obtaining a difference between an output signal of said signal processing circuitry and an input signal of an equalizing means;
approximation means for approximating a gradient of said difference based on said obtained difference and an approximation of said transmission characteristic; and
updating means for updating control values supplied to said equalizing means, based on said approximated gradient.

Accordingly, an adaptive pre-equalizing scheme is provided which is able to learn imperfections of the signal processing circuitry and introduces a pre-distortion of the signal supplied to the signal processing circuitry. Thereby, the specifications or requirements of the signal processing circuitry can be reduced, or, alternatively, freedom is given to accept tighter specifications in future standards.

Moreover, due to the adaptive pre-equalization function, the solution is independent of the kind of signal processing circuitry, e.g. whether a direct conversion or heterodyne architecture is used. The approximation step may comprise the step of calculating an approximation of a least mean square gradient vector of said difference. The gradient vector may be calculated from a partial differential equation of a system cost function.

Furthermore, the difference may be obtained by comparing signal envelopes of said output and input signals. In particular, the input signal may be a digital signal and the output signal may be an analog signal.

The control values may be coefficients of an adaptive digital filter.

Additionally, the transmission characteristic may be approximated as a delay function. In this case, the delay of the delay function may correspond to the position of the maximum analog filter peak in the transmission characteristic.

The comparing means of the equalizing apparatus may be arranged to compare the input and output signals based on their envelopes. Furthermore, the approximation means may be arranged to approximate said transmission characteristic as a delay function and to approximate said gradient by using a least mean square approximation function.

The signal processing circuitry may be a direct conversion or heterodyne transmitter architecture.

The equalizing apparatus may comprise a digital pre-equalizer means.

Advantageous further developments are defined in the dependent claims.

### BRIEF DESCRIPTION OF THE DRAWINGS

In the following, the present invention will be described in greater detail based on a preferred embodiment with reference to the accompanying drawings, in which:

FIG. 1 shows a transmitter architecture comprising an equalizing function according to the preferred embodiment;

FIG. 2A shows a schematic diagram of a known adaptive post-equalization setup;

FIG. 2B shows a schematic diagram of an adaptive pre-equalization setup according to the preferred embodiment;

FIG. 3 shows a pre-equalization scheme according to the preferred embodiment; and

FIG. 4 shows a flow diagram based on the pre-equalization scheme according to the preferred embodiment.

### DESCRIPTION OF THE PREFERRED EMBODIMENT

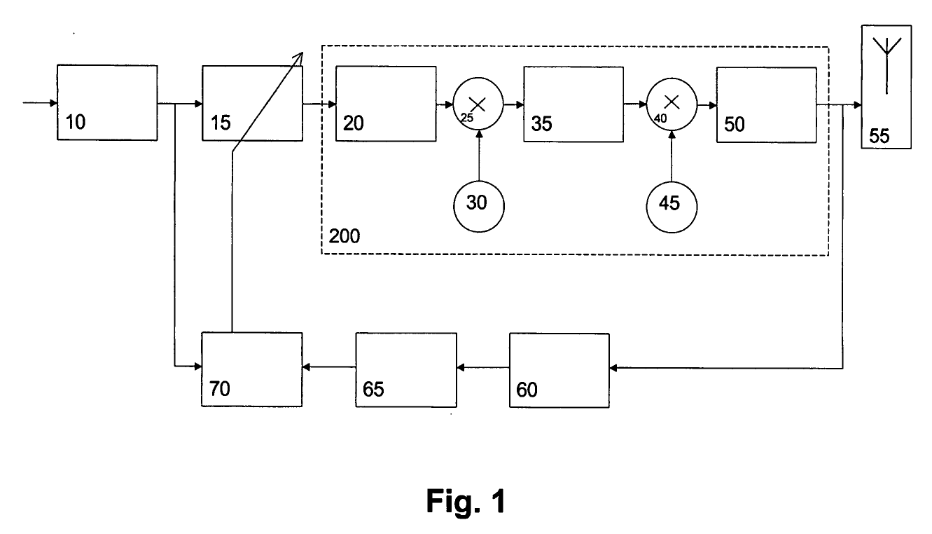

The preferred embodiment of the present invention will now be described on the basis of a heterodyne OFDM transmitter architecture for an IEEE 802.11a wireless LAN transmitter architecture as shown in FIG. 1.

According to FIG. 1, an input signal which may be based on a binary phase shift keying (BPSK), a quadrature phase shift keying (QPSK) or a quadrature amplitude modulation (QAM) is up-converted and low-pass filtered before being supplied in the digital domain to a digital intermediate frequency (IF) circuit 10 at an intermediate frequency of e.g. 20 MHz. The generated IF signal is supplied to an adaptive pre-equalizer 15 arranged to pre-equalize the signal stream such that the distortions generated by non-ideal analog filter circuits of the following stages results again in an accurate signal stream. The pre-equalized signal is supplied to a transmitter circuitry 200, in which the signal is processed for transmission via a transmission antenna 55.

The transmitter circuitry 200 is based on a heterodyne transmitter architecture and comprises an analog base band circuit 20 in which the pre-equalized signal is prepared for transmission, e.g. by applying filtering, channel coding, pulse shaping or other suitable processing operations. Then, the processed base band signal is supplied to a first up-conversion stage comprising a modulator or multiplier 25 to which a signal obtained from a first oscillator 30 at a frequency of e.g. 1.5 GHz is supplied in order to convert the signal frequency to the 1.5 GHz range. Then, the up-converted signal is supplied to an analog IF filter circuit 35 to suppress unwanted frequency components generated by non-linear or other distortions. The filtered up-converted signal is then supplied to a second up-conversion stage comprising a second modulator or multiplier 40 to which an up-conversion signal at an adjustable range of 3.5 to 4.5 GHz is supplied from a controllable second oscillator 54. Thereby, the signal from the analog IF circuit 35 is finally upconverted to an adjustable frequency range of 3.5 to 4.5 GHz. This two-time upconverted radio frequency (RF) signal is supplied to a second filter circuit, i.e. an analog RF filter circuit 50 adapted to pass only the desired frequency range of the transmission signal supplied to the transmission antenna 55.

An envelope measurement circuit 60 which may be based on a clamping and/or low-pass operation or the like provides the envelope signal of the input signal of the transmission antenna 55. This envelope signal is then supplied to an analog/digital converter circuit 65 where it is converted into a digital signal stream supplied to a digital envelope error detection circuit 70. At the envelope error detection circuit 70, the analog/digital converted envelope signal is compared with the digital envelope of the output signal of the digital IF circuit 10 so as to calculate or derive an error value e[k]. In this connection, it is assumed that both envelope signals are synchronized. It is noted that corresponding synchronization circuits are not shown in FIG. 1.

Based on the obtained error value e[k], a predetermined number of control values, e.g. filter coefficients, is derived and supplied to the adaptive pre-equalizer 15 to thereby control the equalizing characteristic. Thus, distortions caused by the nonideal transmitter filters 20, 35, 50 can be measured at the envelope error detection circuit 70 so as to adaptively control the pre-equalizing function. Accordingly, an adaptive decision-aided pre-equalization scheme is provided in the digital domain.

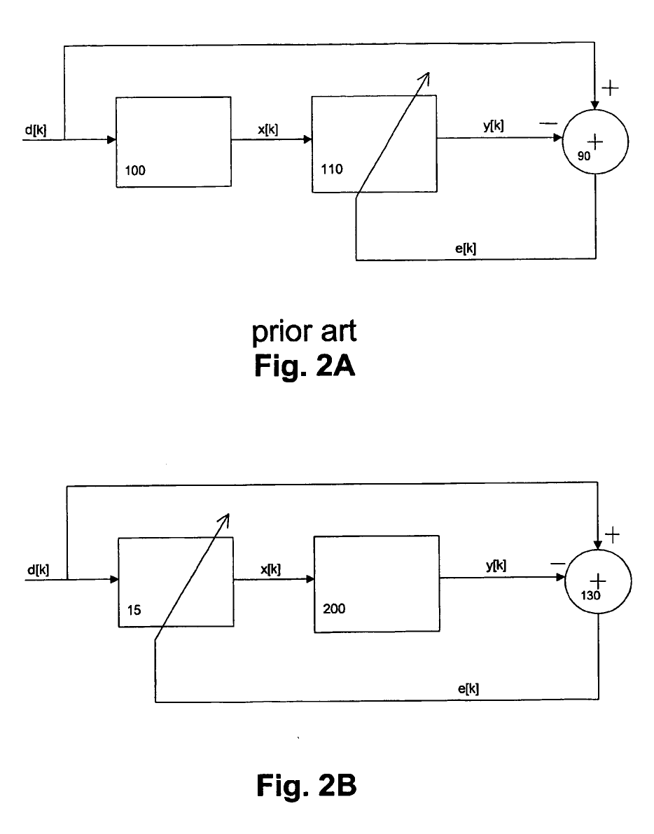

FIG. 2A shows a schematic diagram indicating a known adaptive post-equalization setup, wherein an input data signal first passes a channel 100 and thereafter an adaptive post-equalizer 110. Hence, the adaptive post-equalizer feedback loop comprising the post-equalizer 110 and a subtraction circuit 90 does not include the channel 100. The output signal y[k] of the post-equalizer 110 is subtracted in the subtraction circuit 90 from the input data signal d[k] to thereby obtain an error signal or value e[k] used to control the adaptive post-equalizer 110. The input data signal or vector d[k] first passes the channel 100 which may be characterized by a transfer characteristic or vector. The output signal x[k] of the channel 100 is multiplied with the adaptive filter characteristic or vector of the post-equalizer 110. The resulting scalar value y[k] is subtracted from the input sample d[k], and the obtained error value e[k] is used to update the filter coefficients of the adaptive postequalizer 110 for the next input samples. It is thus not necessary to know the channel transfer characteristic or vector explicitly, because the input data x[k] of the post-equalizer 110 automatically contains the channel information. Thus only one unknown value, i.e. the optimal coefficient vector must be determined. However, in the pre-equalization process according to the preferred embodiment of the present invention, the equalizer is put in front of the non-ideal analog filters or channel and hence includes the analog filters or channel in its feedback loop. Therefore, the calculation of the optimal coefficient vector is based on two unknown variables or vectors, the analog filter transfer characteristic or vector and the optimal coefficient set of the adaptive pre-equalizer.

FIG. 2B shows a corresponding adaptive pre-equalization setup which is based on the preferred embodiment shown in FIG. 1. According to FIG. 2B, the adaptive preequalizer 15 generates an input signal x[k] for the transmitter circuitry 200, wherein the output signal y[k] of the transmitter circuitry 200 is supplied to a subtractor or comparison circuitry 130 to which the input data signal d[k] is also supplied in order to obtain the error value e[k] based on which the pre-equalizer 15 is controlled.

The pre-equalization approach shown in FIG. 2B can be described based on the following equations:
x[k]=d^{T}[k]·w[k] (1)
y[k]=x^{T}[k]·h[k] (2)
In the above equations (1) and (2), w[k] denotes the coefficient or weight vector of the pre-equalizer 15, and h[k] denotes the transfer vector of the transmission circuitry 200.

Based on the above two equations (1) and (2), the error value e[k] can be obtained based on following equation.
e[k]=d[k]−y[k]=d[k]−x^{T}[k]·[k] (3)

Inserting equation (1) to equation (3) results in the equation:
e[k]=d[k]−(D^{T}[k]·w[k])^{T}·h[k] (4)

According to the preferred embodiment of the present invention, the above equation (4) with its two unknown vectors can be solved based on an approximation and a single adaptation processing. The approximation can be performed for a gradient vector of the error value e[k]. In particular, a least mean square (LMS) gradient vector can be determined. The starting point for the determination of the gradient approximation is the above equation (4). The following equation describes a system cost function J{w[k]} used for the gradient approximation:
J{w[k]}=E<e²[k]>=E<(d[k]−y[k])²>=E<(d[k]−w^{T}[k]·D[k]·h[k])²> (5)
Consequently, the gradient vector of the error performance function can be obtained on the basis of a partial differentiation of the above system cost function.
This leads to the following equation:
∇{E<e²[k]>}=−2·E<e[k]·x⁻[k]> (6)
wherein x⁻[k] denotes a direction vector of the gradient, which corresponds to an assessment of the data matrix D[k] with the transfer vector h[k] of the transmitter circuitry 200. This can be described on the basis of the following equation:
x^{˜}[k]=D[k]·h[k]=h_{τ}·d[k−τ]=d[k−τ] (7)
wherein the data matrix D[k] represents a transformation matrix, which rotates the non-ideal transfer vector h[k] of the transmitter circuitry 200, h_{τ} provides the approximated analog filter transfer value, e.g. h_{τ}=1 (while all other coefficients of the transfer vector are set to “0”).

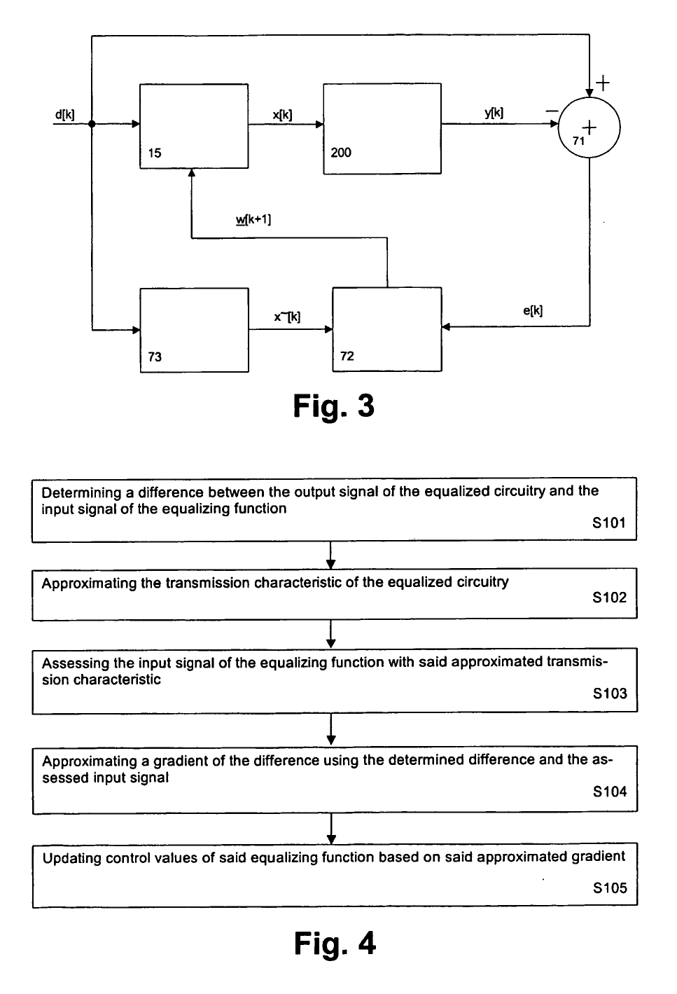

FIG. 3 shows an implementation example of the envelope error detection circuitry 70 in FIG. 1 based on the adaptive pre-equalization setup scheme of FIG. 2B. It is noted that in FIG. 3, the envelope measurement circuit 60 and the analogdigital converter 65 have been omitted for reasons of simplicity. Thus, the output value y[k] of the transmitter circuitry 200 corresponds to the digitized output value of the analog/digital converter 65.

In FIG. 3, the output signal y[k] is supplied to a subtraction circuit 71 which generates the error value e[k]. This error value e[k] is supplied to an adaptation circuit 72 arranged to determine an updated or new coefficient vector w[k+1] for controlling the pre-equalizer 15. Furthermore, an approximation circuit 73 is provided for approximating the transfer characteristic or transfer vector h[k] of the transmitter circuitry 200. Accordingly, the output signal of the approximation circuit 73 corresponds to the above signal vector x⁻[k]. In view of the fact that the transfer vector t[k] is approximated in the approximation circuit 73, only one unknown variable has to be determined in the adaptation circuit 72.

In the following, the derivation of the pre-equalization coefficient vector w[k+1] is described.

The signal vector x⁻[k] can be obtained by implementing a copy of the analog filter characteristic of the transmitter circuitry 200 in the approximation circuit 73. However, this would also require an identification process of this analog filter characteristic. As an advantageous simplified solution, the approximation circuit 73 may be adapted to implement the filter characteristic of the transmitter circuitry 200 as a simple delay block or function. Then, the required delay value corresponds to the analog filter delay τ, i.e. the position of the maximum filter peak of the analog filter characteristic of the transmitter circuitry 200. This maximum peak can then be replaced by a value “1” in the transfer vector h[k], while the other vector components can be set to “0”.

The analog filter characteristic of the transmitter circuitry 200 can thus be approximated by a simple FIR (Finite Impulse Response) filter with estimated coefficient h_{τ}[k]=“1” and all other coefficients set to “0”.

This approximation leads to a simplification of the above equation (6), as follows:
∇{E^{#}<e²[k]<}=−2·e[k]·d[k−τ] (8)

Based on the simplified equation (8), the coefficients of the pre-equalizer 15 can be updated on the basis of the following equation:
w[k+1]=w[k]+μ·e[k]·d[k−τ] (9)

Using the above approximation, a straight forward calculation or determination of the coefficients of the adaptive pre-equalizer 15 is possible in the adaptation circuit 72.

FIG. 4 shows a more general flow diagram of the steps of the above adaptive preequalization scheme according to the preferred embodiment. In step S101, a difference between the output signal y[k] of the equalized circuitry, i.e. the transmission circuitry 200, and the input signal d[k] of the equalizing function of the pre-equalizer 15 is determined. This difference corresponds to the error value e[k] and may be based on a comparison of the signal envelopes as explained earlier. However, any other signal parameter can be used for obtaining the difference. Then, in step S102, the transmission characteristic of the equalized circuitry is approximated. Here, any approximation can be applied so as to derive one of the two unknown variables in equation (4). Then, the input signal of the equalizing function is assessed with the approximated transmission characteristic (step S103). Based on the determined difference and the assessed input signal, a gradient of the difference is approximated e.g. based on equation (8) (step S104). Having derived the gradient of the difference, the control values or coefficients of the pre-equalizing function are updated in step S105 based on the approximated gradient.

The present invention provides a proposal for an adaptive pre-equalization approach which may be used e.g. for an analog filter characteristic of a transmitter circuitry or any other signal processing circuitry. The equalization is based on an approximation, e.g. an LMS approximation, and does not require a system identification process with respect to the analog filter characteristic, but approximates this characteristic by a simple delay block or any simplified transfer characteristic. Thereby, a highly flexible approach is provided, since variations in the characteristic of the transmitter circuitry 200 do not have to be taken into account. In fact, imperfections are learned, a model is made, and the model is used in pre-distorting the signal before applying it to the transmitter chain. Thereby, even changes in the transmitted signal wave form due to transmitter imperfections can be compensated. The invention gives the freedom to accept or promote tighter specifications with respect to the magnitude of the error value or vector in future standards. Furthermore, multipath delay spread tolerance can be improved by reducing intersymbol interference (ISI) which results from group delay equalization. The proposed adaptive low-complexity solution suites very well to volume production needs allowing larger tolerances for specifications. This may lead to an improved production yield.

It is noted that the present invention is not restricted to the preferred embodiment described above but can be used in any signal processing circuitry for reducing signal distortions. The comparison can be performed for any signal parameter suitable to obtain a difference caused by distortions of the signal processing circuitry. The transfer characteristic of the signal processing circuitry can be approximated by any suitable approximation. Similarly, the control values for controlling the pre-equalizer may be obtained by any suitable approximation for obtaining a gradient of the difference value or error value. The pre-equalization may be adapted for use in heterodyne architectures or direct conversion architectures. It may as well be used for compensating amplitude imperfections, e.g. in-phase (I) and quadrature phase (Q) amplitude imperfections, for direct conversion architectures. The preferred embodiments may thus vary within the scope of the attached claims.

1. A method of pre-equalizing a transmission characteristic of a signal processing circuitry , said method comprising the steps of:
a) obtaining a difference between an output signal of said signal processing circuitry and an input signal of an pre-equalizing function;
b) approximating a gradient of said difference based on said obtained difference and an approximation of said transmission characteristic; and
c) updating control values of said equalizing function (15) based on said approximated gradient.

2. A method according to claim 1, wherein said approximating step comprises the step of calculating an approximation of a least mean square gradient vector of said difference.

3. A method according to claim 2, wherein said gradient vector is calculated from a partial differential equation of a system cost function.

4. A method according to claim 1, wherein said difference is obtained by comparing signal envelopes of said output and input signals.

5. A method according to claim 4, wherein said input signal is a digital signal and said output signal is an analog signal.

6. A method according to claim 1, wherein said control values are coefficients of an adaptive digital filter.

7. A method according to claim 1, wherein said transmission characteristic is approximated as a delay function.

8. A method according to claim 7, wherein the delay of said delay function corresponds to the position of the maximum analog filter peak of said transmission characteristic.

9. A method according to claim 8, wherein said gradient vector is calculated using the following equation:
∇{E}=−2e[k]·d[k−τ],
wherein
∇{E} denotes said gradient vector,
e[k] denotes said obtained difference, and
d[k−τ] denotes a vector representation of said input signal assessed by said delay approximation of said transmission characteristic.

10. A method according to claim 9, wherein filter coefficients are updated in said updating step based on the following equation:
w[k+1]=w[k]+μe[k]·d[k−τ],
wherein
w[k+1] denotes a vector representation of updated filter coefficients,
w[k] denotes a vector representation of current filter coefficients, and
μ denotes a predetermined proportionality factor.

11. An apparatus for pre-equalizing a transmission characteristic of a signal processing circuitry, said apparatus comprising:
a) comparing means for obtaining a difference between an output signal of said signal processing circuitry and an input signal of an pre-equalizing means
b) approximation means for approximating a gradient of said difference based on said obtained difference and an approximation of said transmission characteristic; and
c) updating means for obtaining control values supplied to said preequalizing means, based on said approximated gradient.

12. An apparatus according to claim 11, wherein said comparing means are arranged to compare said input and output signals based on their envelopes.

13. An apparatus according to claim 11 or 12, wherein said approximation means is arranged to approximate said transmission characteristic as a delay function and to approximate said gradient by using a least mean square approximation function.

14. An apparatus according to claim 11, wherein said signal processing circuitry is a direct conversion or heterodyne transmitter architecture.

15. An apparatus according to claim 11, wherein said apparatus comprises a digital pre-equalizer means.
